(19) United States
(12) Patent Application Publication
(10) Pub. No.: US 2022/0267667 A1
(43) Pub. Date: Aug. 25, 2022

(54) SMART NANOSCALE MATERIALS WITH COLLOIDAL CORE/SHELL NANOPARTICLES

(71) Applicant: Lawrence Livermore National Security, LLC, Livermore, CA (US)

(72) Inventors: Jinkyu Han, San Ramon, CA (US); Thomas Han, Livermore, CA (US)

(21) Appl. No.: 17/183,007

(22) Filed: Feb. 23, 2021

(51) Int. Cl. C09K 11/02; G02F 1/166; C09K 11/77

(52) U.S. Cl. CPC C09K 11/025; G02F 1/166; C09K 11/7773; G02F 2001/1678

(57) ABSTRACT

A product includes a cell having a mixture comprising a solvent and colloidal nanoparticles. Each of the colloidal nanoparticles have a core and a shell surrounding the core. The cell also includes at least one electrode. A product includes a nanoparticle having a core and a shell. The core includes a luminescent material. The shell is silicon-based. A method includes applying an external stimulus to a cell containing a mixture comprising a solvent and colloidal nanoparticles for altering the brightness and/or color of an assembly of at least some of the colloidal nanoparticles. Each of the colloidal nanoparticles have a core and a shell surrounding the core.

This invention was made with Government support under Contract No. DE-AC52-07NA27344 awarded by the United States Department of Energy. The Government has certain rights in the invention.

### FIELD OF THE INVENTION

The present invention relates to core/shell nanoparticles, and more particularly, this invention relates to smart nanoscale materials with colloidal core/shell nanoparticles.

### BACKGROUND

Exploration in smart optical materials is directed toward use in scientific research, consumer goods, and military applications. In the past decade, one promising smart optical material, photonic crystals (PCs), has shown potential in design of remarkable optical responses. However, PC research has been primarily focused on the development of light reflection characteristics due to difficulties in fabrication of constituent materials of PCs and their structures.

### SUMMARY

A product, according to one general aspect, includes a cell having a mixture comprising a solvent and colloidal nanoparticles. Each of the colloidal nanoparticles have a core and a shell surrounding the core. The cell also includes at least one electrode.

A product, according to another general aspect, includes a nanoparticle having a core and a shell. The core includes a luminescent material. The shell is silicon-based.

A method, according to yet another general aspect, includes applying an external stimulus to a cell containing a mixture comprising a solvent and colloidal nanoparticles for altering the brightness and/or color of an assembly of at least some of the colloidal nanoparticles. Each of the colloidal nanoparticles have a core and a shell surrounding the core.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1A is a cross-sectional view of core/shell colloidal nanoparticles, according to one aspect.

FIG. 1B is a schematic drawing of a suspended particle device with colloidal nanoparticles in the absence of an applied electrical field, according to one aspect.

FIG. 1C is a schematic drawing of a suspended particle device with colloidal nanoparticles in the presence of an applied electrical field, according to one aspect.

FIG. 2 is a flowchart of a method, according to one aspect.

FIG. 3 is a diagram of the hypothesized effect of spectral overlap between the stop-band of the PC and excitation and emission spectra of luminescent nanoparticles on the emission output, according to one aspect.

FIG. 4 is a photograph of ZnS/SiO₂ suspensions in an EPD cell with a background on the backside of the device at the (A) OFF and the (B) ON state, according to one aspect.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred aspects of smart nanoscale materials with colloidal core/shell nanoparticles and/or related systems and methods. In various aspects, “nanoscale” as referred to throughout the present disclosure includes to materials, particles, objects, etc., having at least one dimension of less than 1000 nanometers.

In one general aspect, a product includes a cell having a mixture comprising a solvent and colloidal nanoparticles. Each of the colloidal nanoparticles have a core and a shell surrounding the core. The cell also includes at least one electrode.

In another general aspect, a product includes a nanoparticle having a core and a shell. The core includes a luminescent material. The shell is silicon-based.

In yet another general aspect, a method includes applying an external stimulus to a cell containing a mixture comprising a solvent and colloidal nanoparticles for altering the brightness and/or color of an assembly of at least some of the colloidal nanoparticles. Each of the colloidal nanoparticles have a core and a shell surrounding the core.

Various aspects of the present disclosure enable dynamic and dramatic tuning of the luminescence output of photonic crystals (PCs) using luminescent core/shell nanocrystals as constituents of PCs with structural control using self-assembly and directed-assembly. The transmission and reflection features combined with luminescence properties are dynamically tunable in response to application of an external stimulus, e.g., an electrical field.

There has been an increase in exploration in the optics of smart materials for scientific research, consumer goods, and military applications. Colloidal PCs are a promising smart optical material which many research groups have endeavored to engineer the optical properties of for use in practical applications such as displays, solar cells and sensors. As described throughout the present disclosure, PCs are composed of a three-dimensional array of dielectric lattice in a substantially periodic arrangement with a length scale on the order of visible wavelength. The inventors have designed remarkable optical responses of PCs by controlling structural parameters of PCs (e.g., lattice parameters, interparticle distance, crystal structure, refractive index, etc.). Specifically, characteristics of PCs guide a range of wavelengths to be transmitted and/or reflected. These light-matter interactions are strongly correlated to the photonic band gap characteristics (e.g., stop- and pass-band), which are determined by the structural parameters of PCs.

A challenging aspect of expanding the functionality and versatility of PCs includes the difficulty of fabricating uniform and size controllable optical materials as building blocks in PCs. Conventional materials used as the constituents in PCs are “inert” silica, polystyrene and poly(methyl methacrylate). The role of these constituents is typically restricted to be structural components to make periodic structures and thus the optical characteristics of the constituents themselves (e.g., absorption and emission) are negligible. Furthermore, the structural parameters of PC to tune light-matter interactions are strongly affected by particle size and poly-dispersity of constituents.

Up until the present disclosure, PC research has been primarily focused on the development of light reflection characteristics for display applications and the study of constituent materials of PC has not been extensively examined and developed due to difficulties in fabrication of such materials and structures. These challenges provide opportunities for new approaches and discoveries derived from material sciences for smart optical materials with improved functionalities and capabilities. For example, PCs, according to at least some aspects described herein, enable on demand control of various types of light-matter interactions (e.g., transmission, emission, absorption, etc.) by tuning constituent materials of PC as well as the characteristics of photonic band gap of PCs. According to Purcell effect (see, E. M. Purcell “Spontaneous emission probabilities at radio frequencies” Phys. Rev. 69, 681 (1946)), the enhancement of a luminescent molecule's emission rate is determinable based in the molecule's environment and it has been experimentally demonstrated that there are strong light-matter interactions between luminescence materials and PC structures. More specifically, the luminescence output can be dramatically enhanced or reduced (e.g., over ten-fold enhancement/reduction than the unstructured nanoparticles) by designing and manipulating structural parameters of PCs and/or applying external stimulus or stimuli (see, Lin, Y. S.; Hung, Y.; Lin, H. Y.; Tseng, Y. H.; Chen, Y. F.; Mou, C. Y. Photonic crystals from monodisperse lanthanide hydroxide at silica core/shell colloidal spheres. Advanced Materials 2007, 19, 577-580).

At least some aspects of the present disclosure provide highly efficient luminescent core/shell nanocrystals with ideal particle size and structural parameters of the luminescent core/shell nanocrystal assemblies in response to external stimuli to dynamically tune emission and absorption properties of assemblies of PCs. Electric field induced directed assemblies are used to dynamically control nanoparticle assemblies. At least some aspects use the native surface charge present on colloidal particles suspended in a solvent to translate particles to an electrode where the particles assemble into a deposit. Since the electric field can be efficiently applied to large areas (e.g., up to square meters) and the response time is fast (e.g., on the order of microseconds), various aspects enable dynamic control of the structural parameters of the PCs, resulting in the change of photonic band gap properties, thereby enabling the ability to tune various light-matter interactions in response to applied electric fields. The luminescence output of PCs may be dramatically and dynamically tunable using luminescent nanocrystals as constituents of PCs as well as electric field induced directed assembly. Furthermore, the transmission and reflection features combined with luminescence properties are dynamically tunable by controlling electric field, the choice of materials, the particle size, the device design, etc.

At least some preferred aspects of the present disclosure produce and demonstrate smart optical materials to perform multifunctional characteristics (e.g., optical bandgap control, tunability with luminescence/transmission enhancements, etc.) by utilizing responsive PCs constructed by luminescent core/shell nanocrystals as constituents.

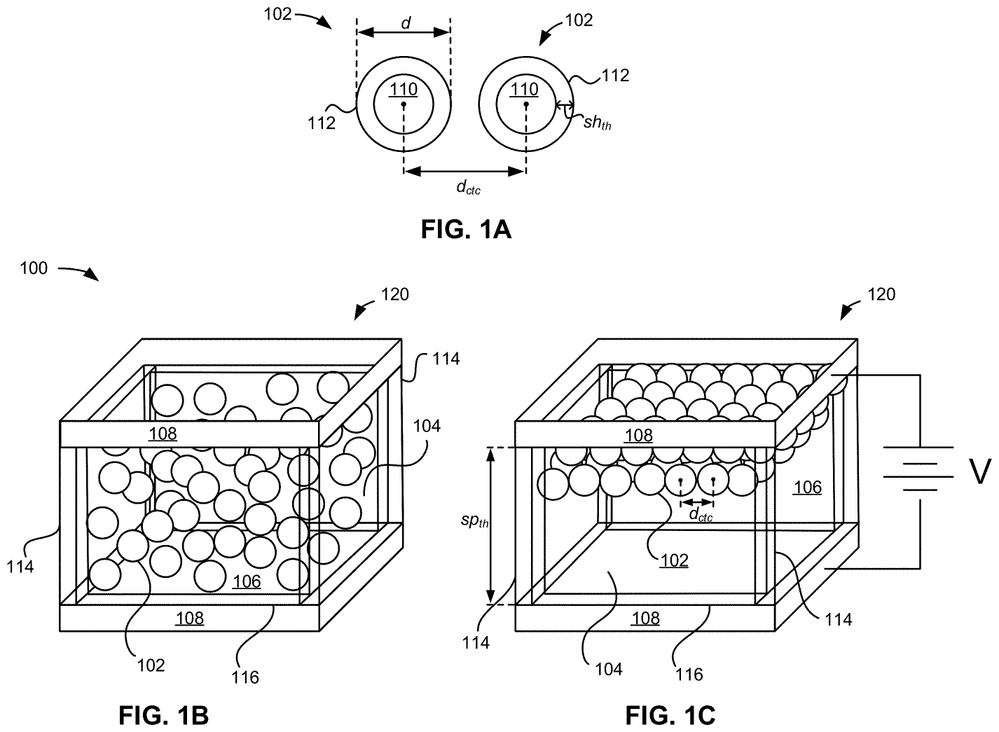

FIG. 1A depicts a core/shell nanoparticle 102, in accordance with one aspect. As an option, the present nanoparticle 102 may be implemented in conjunction with features from any other aspect listed herein, such as those described with reference to the other FIGS. Of course, however, such a product and others presented herein may be used in various applications and/or in permutations which may or may not be specifically described in the illustrative aspects listed herein. Further, the product presented herein may be used in any desired environment.

In one aspect, a product may include a plurality of generally spherical colloidal nanoparticles 102 each having a core 110 and a shell 112 surrounding the core 110, as illustrated in a cross-sectional view in FIG. 1A. The term “generally spherical” means the nanoparticles 102 have an average diameter that does not vary by more than a ratio of 1:2 from shortest to longest dimension and ideally not more than 1:1.5.

In preferred aspects, each core 110 of the colloidal nanoparticles comprises luminescent material. In some aspects, the cores of the colloidal nanoparticles may be light emitting, e.g., may have a known light emitting material therein. In one approach, the luminescent material may be phosphor-based. In other approaches, the luminescent material includes quantum dots. In yet other approaches, the luminescent material includes rare earth activated luminescent and/or upconverting materials, rare-earth activated lanthanide oxide, fluoride, a sulfide such as LaPO₄, NaYF₄, Y₂O₃, Ga₂O₃, CePO₄, ZnS, CdS, where the rare earth activators includes europium, cerium, terbium, ytterbium, thulium, etc. In further approaches, the luminescent material includes combinations of the foregoing materials, quantum dots and/or elements.

In some aspects, the core comprises materials which may be light absorbing or reflecting in selected regions of the electromagnetic spectrum. Core particles with band gap (E_{g}) range from 1.8 eV to 3.1 eV can absorb and reflect the visible light. Illustrative materials include CdS, CdSe, Fe₂O₃, WO₃, and GaP. When the core particles absorb in one region of the light, they appear with complimentary color by the light reflection. For example, violet light absorbing core particles such as CdS can reflect the yellow light. When core particles with larger band gap (E_{g}>3.2 eV) such as ZnO, ZnS, TiO₂, and SiO₂, all the light in the visible spectrum can be not absorbed but reflected. Furthermore, core particles composed of Cr³⁺, Cu²⁺, and Co²⁺ compounds such as Cr₂O₃ (green), CuO (green) and Al₂CoO₄ (blue) can also reflect the light in the visible range by inter-atomic excitation.

In an exemplary aspect, the core of the nanoparticle may include a pigmentary material, for example, a highly faceted single crystal α-Fe₂O₃, that may enhance the color contrast with pigment-induced absorption.

In various aspects, at least some of the cores 110 may include a colorant, for example, but not limited to, a dye, a pigment, etc., may be applied to a base material of the cores 110. In other approaches, the base material of the core 110 may be selected to provide a color.

In some aspects, the shell 112 that surrounds the core 110 of the nanoparticle 102 may be silicon-based. In some approaches, the shell 112 may have a negative charge, and include materials such as silica, titanium, etc. For example, according to Stöber method, which is an example of sol-gel process, negatively charged SiO₂ shells can be fabricated by the hydrolysis and condensation process of tetraethyl orthosilicate (TEOS) (e.g., silica precursors) in the presence of water and ammonia. In other approaches, the shell 112 may have a positive charge by the surface modification using silane coupling agents.

In some aspects, the shell may improve the suspension properties of the colloidal nanoparticles in the solvent. According to various aspects, the shell thickness shₜₕ may affect the interparticle distance that may be defined by the core-to-core distance d_{ctc} between adjacent nanoparticles. In some approaches, the interparticle distance may be referred to as the intercore distance. In one aspect, the shell 112 may control the distance d_{ctc} between the cores of neighboring colloidal nanoparticles, as indicated on FIG. 1A. In some approaches, the shell may control the ordering of the colloidal nanoparticles.

In an exemplary aspect, nanoparticles with a shell 112 having a thinner shell thickness shₜₕ may have a shorter interparticle distance d_{ctc} than nanoparticles 102 with a shell 112 having a thicker shell thickness shₜₕ. Thus, the shell thickness shₜₕ of the nanoparticles 102 may define the interparticle distance d_{ctc} between the nanoparticles 102 of a concentration of nanoparticles 102 in a mixture 106 and, thereby determine the reflectance and structural color of the mixture 106 during assembly of the nanoparticles 102 with an applied electric field V.

In various aspects, the shell properties of the colloidal nanoparticles may be selected for particular applications. In some approaches, the shell may have hydrophobic properties. In other approaches, the shell may have hydrophilic properties.

In an exemplary aspect, the shell of the nanoparticle may include a SiO₂ coating that may improve the suspension properties and control the intercore distances, as indicated by d_{ctc} in FIG. 1A. A shell of silica material may contribute to the structural colors. Moreover, the surface charge of Fe₂O₃ core particles with a SiO₂ shell (Fe₂O₃/SiO₂ nanoparticles) may be negative due to the ionization of the surface hydroxyl groups of the SiO₂ shell. Thus, negatively charged Fe₂O₃/SiO₂ nanoparticles may assemble in an ordered pattern as the particles concentrate on the positive electrode under an external electric field, resulting in structural color changes.

According to an exemplary aspect, the assembly and tuning of Fe₂O₃/SiO₂ core/shell nanoparticle arrays allow the generation of tunable structural colors with distinct reflected and transmitted color behaviors. The use of Fe₂O₃/SiO₂ core/shell nanoparticles with a moderate polydispersity (for example, δ≈7%, as may be confirmed by synchrotron-based ultrasmall-angle X-ray scattering (USAXS)), along with a variation in the shell thickness and/or particle concentration may provide multiple pathways to tune the color spectrum of the assembly of nanoparticles. In some approaches, the color tunability observed by varying the concentrations may also be emulated by modulating the electric field applied to a diluted suspension of particles inside an electrophoretic deposition (EPD) cell.

In various aspects, the nanoparticles 102 may have an average diameter d, as shown in FIG. 1A, in a range of about 5 to about 300 nanometers, more preferably in a range of about 5 to about 200 nanometers. In an exemplary aspect, the nanoparticles 102 may have an average diameter d in a range of about 100 to about 150 nanometers. In yet other exemplary aspects, the nanoparticles 102 may have an average diameter d which is greater than about 300 nanometers, but preferably less than about 1000 nanometers.

FIGS. 1B-1C depict a product of an electro-optical device with a plurality of such core/shell nanoparticles, in accordance with one aspect. As an option, the present product 100 may be implemented in conjunction with features from any other aspect listed herein, such as those described with reference to the other FIGS. Of course, however, such a product 100 and others presented herein may be used in various applications and/or in permutations which may or may not be specifically described in the illustrative aspects listed herein. Further, the product 100 presented herein may be used in any desired environment.

In one aspect as shown in FIGS. 1B and 1C, a product 100 includes a mixture 106 of a solvent 104 and generally spherical colloidal nanoparticles 102.

The solvent 104 in the mixture 106 may be a polar solvent. In various aspects, the solvent (e.g., suspending medium) may be chosen so as to maintain the suspended colloidal nanoparticles in gravitational equilibrium. In some aspects, the solvent may provide electrochemical stability with a dielectric constant greater than about 30 and may have a boiling point greater than about 150 degrees Celsius. For example, but not limited to, the solvent 104 may include propylene carbonate, dimethylformamide, dimethyl sulfoxide, etc. In some approaches, the suspension of colloidal nanoparticles may be enhanced by a liquid suspending medium that includes one or more non-aqueous, electrically resistive liquids with high dielectric constants.

The product 100, according to one aspect, also includes an electrode 108. According to one aspect, as shown in FIGS. 1B and 1C, an electrode 108 may be positioned on either end of a cell 120 with spacers 114, 116 in between the electrodes 108. The mixture 106 of solvent 104 and spherical colloidal nanoparticles 102 may be contained between the electrodes 108 and spacers 114, 116. In the cell 120, a voltage V may be applied to the electrodes 108.

In some aspects, the electrodes 108 may be transparent (for example, but not limited to, not opaque, translucent, etc.) and preferably allows at least 90% light transmission therethrough.

In various aspects, the thickness of the cell that contains the mixture 106 may be defined by the thickness spₜₕ of the spacers 114 that are positioned between the electrodes 108. The path of light through the electrodes 108 (the electrodes may be transparent) may determine not only the reflected color of the cell by controlling the relative intensity of structural and pigmentary colors of the mixture of colloidal nanoparticles in dielectric solvent but also the light transmissivity. In one aspect, the reflected color and the light transmissivity may be tuned by the spacer thickness spₜₕ that defines the cell thickness between the electrodes 108. As an example, but not limiting to the aspects described herein, the reflected colors as well as the light transmittance observed in the absence and presence of applied voltage under same electric field with a spacer thickness spₜₕ of 500 μm spacing may be significantly different from the reflected colors and the light transmittance observed with a spacer thickness spₜₕ of 5 μm spacing under the same conditions of electric field. The difference in reflected colors between the two thicknesses may be due to enhanced relative intensity of pigmentary color and possibly different response of the mixtures in each cell to electric stimuli. Furthermore, the difference in transmissivity between the two thicknesses may be due to higher scattering events in thicker cell thereby reducing the transmission of the incident light.

According to an exemplary aspect, the photonic color of a mixture with a 500 μm spacing between the electrodes may change from yellow to pink and then to deep red as the applied voltage increases. Some aspects demonstrate the versatility of the EPD cell device which may be used to generate the full visible color spectrum via controlling the spacer thickness, particle concentration, silica shell thickness (shₜₕ of SiO₂), and applied voltage. In some aspects, the mixture includes a specific color, the mixture being characterized as changing color across the visible spectrum in direct correlation to a concentration of the colloidal nanoparticles. The concentration of the colloidal nanoparticles may be selected to provide the specific color of the mixture.

According to one aspect, the product 100 may include at least one spacer 114 (for example, barrier, gasket, etc.) for forming a chamber having sides defining an interior. Moreover, the mixture 106 may be in the interior of the chamber.

FIGS. 1B and 1C show schematic drawings of fabricated three-layered suspended particle device (SPD) cell 120 that includes the colloidal nanoparticle suspension layer between transparent top and bottom electrodes of conventional construction. In some approaches, the electrodes 108 may be transparent indium tin oxide (ITO) glass or poly(ethylene terephthalate) electrodes. FIG. 1B shows the cell 120 with a mixture 106 in the absence of applied voltage (“off” state). The colloidal nanoparticles 102 may remain in suspension in the solvent 104. In various aspects, the mixture 106 may have reduced transparency of no greater than 50%, preferably no greater than 33%, and in some approaches no greater than 10% light transmission (for example, at least partially opaque, not translucent, etc.), when there is no voltage applied to the electrode 108. In the absence of applied electrical field, colloidal nanoparticles in the liquid suspension are likely located in random positions due to Brownian motion or the particles in the suspension may be arranged with weak correlation to each other.

FIG. 1C shows a schematic of the cell 120 with a mixture 106 in the presence of applied voltage V (“on” state). As shown, colloidal nanoparticles can be assembled on the positive electrode under an external electric field due to their negative surface charge resulting in transparency of at least 90% light transmission. Moreover, assembling of colloidal nanoparticles during applied electrical field may result in structural color as well as transmission changes. The resulting nanoparticle arrangements that result in transparency and/or color change may occur from the balance between the electrostatic repulsion between the particles and the assembly of colloidal particles at the electrode in the presence of an electric field.

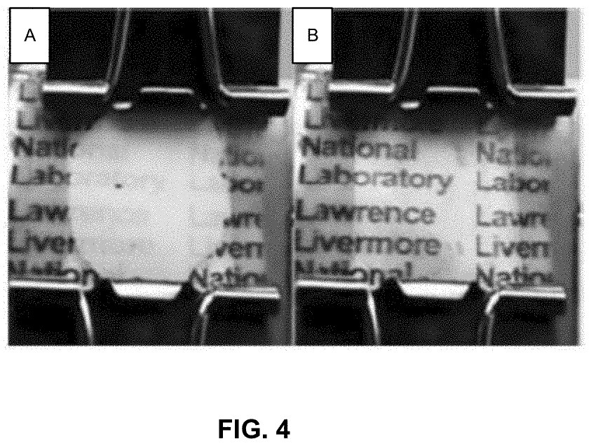

In various aspects, the clarity of the view through the cell 120 with the mixture 106 may be improved in the presence of an electrical field. For example, the clarity of the view may be improved where the light transmission is increased through the cell 120 with the mixture 106 in the visible range. In some aspects, the clarity of the view through the cell 120 with the mixture 106 may be proportional to an amount of light transmitted through the cell 120 with the mixture 106. In some aspects described herein, a mixture that is “optically clear” and/or is characterized as having “relatively high optical clarity” refers to a material that is substantially free (e.g., greater than 95% free, preferably greater than 99% free) of optical grain boundaries or light scatter defects, such that the view through the mixture in the cell is optically clear in the visible range in the presence of the electrical field. Moreover, optically clear materials are those through which light propagates essentially uniformly and are capable of transmitting at least about 90% of incident light. In one approach, optical transparency may be measured as the material having scattering of light less than about 5% per cm. For example, the view (e.g., the optical clarity) through the cell 120 with the mixture 106 and light transmission though the cell 120 with the mixture 106 would be relatively higher in the assembly shown in FIG. 1C as compared to the view and the light transmission in the assembly shown in FIG. 1B. Moreover, as shown in FIG. 4, described in further detail below, the (A) OFF state is analogous to FIG. 1B and the (B) ON state is analogous to FIG. 1C where the (B) ON state is characterized as having a relatively higher degree of optical clarity (e.g., the letters (with a white paper put on the backside of the cell) are relatively darker and more distinct through the view of the cell having the mixture in the (B) ON state).

In some aspects, the mixture 106 may create a difference between transmitted and reflected colors in the cell 120 with applied electric field. In an exemplary aspect, the behavior of the mixture of colloidal Fe₂O₃/SiO₂ nanoparticles in dielectric solvent may give rise to behavior comparable with the Lycurgus cup effect, in which the transmitted and reflected colors in the cell is attributed to the difference between the pigmentary color (intrinsic color) of Fe₂O₃/SiO₂ and the structural color from Fe₂O₃/SiO₂ nanoparticle arrangement.

Without wishing to be bound by any theory, the inventors believe the transparency change may be obtained more clearly in a device with mono-dispersed particles with a spherical shape because there is a reduction of the scattering centers such as pores and grain boundaries when these particles are concentrated in the presence of an electrical field. Furthermore, it appears the increased transparency may be attributed to an enhanced crystallinity of nanoparticle arrangement. In the presence of an electric field, the nanoparticle structure may have enhanced crystallinity and periodic arrangement, thereby increasing the transparency as compared with the random or less ordered particle structure in the absence of an electric field. Furthermore, the defects (e.g., scattering centers) such as pores and grain boundaries in the structure appear to be reduced by densification of colloidal nanoparticles at a larger electric field.

In various aspects, the core/shell colloidal nanoparticles may be suspended in highly dielectric liquid media with optimal concentration for electrical responded color and transparency tunable device. In the presence of an applied electrical field, the colloidal nanoparticles may assemble and generate a transparency in the suspension thereby creating an optical stop and pass band.

In one aspect, light-emitting core/shell colloidal nanoparticles have enhanced light-emitting properties as the core/shell colloidal nanoparticles may undergo light transparency structural behavior in an SPD device in the presence of applied electrical field. In some approaches, application of the electric field causes the light-emitting nanoparticles to assemble, and thereby may enhance the apparent light-emitting properties of the nanoparticles (such as the light emitting from the device becomes brighter).

In some aspects, the mixture 106 may be characterized as having a transparency that increases as a voltage V of the electrode 108 increases. The transparency to light may occur in a predetermined wavelength range. In some approaches, the predetermined wavelength range may be in the visible region. In other approaches, the predetermined wavelength range may be in the UV range. In yet other approaches, the predetermined wavelength range may be in the infrared (IR) range.

In some aspects, the core/shell colloidal nanoparticle may be tuned to a predetermined wavelength region in the presence of applied electric field. For example, various optical and/or luminescent properties of the core/shell colloidal nanoparticles may be tuned in the presence of an electrical field. In contrast, some inherent optical and/or luminescent properties of the core/shell colloidal nanoparticles are unchanged by the applied electric field, as would become apparent to one having ordinary skill in the art upon reading the present disclosure. In some approaches, the size of the nanoparticle core may be tuned to a predetermined wavelength. In other approaches, the thickness of the shell may be tuned to a predetermined wavelength. In yet other approaches, one or more of the characteristics of the core/shell colloidal nanoparticle may be tuned to a predetermined wavelength.

In some aspects, the predetermined wavelength range may be only a portion of the wavelengths in the ultraviolet to infrared range. In some approaches, the transparency of the mixture may not significantly change for a second wavelength range in the ultraviolet to infrared range as the voltage of the electrode increases. The second wavelength range may not overlap the wavelength range for which a bandgap effect is desired. In some approaches, the second wavelength range may be within the predetermined wavelength range. In other approaches, the second wavelength range may be overlapping the predetermined wavelength range. In yet other approaches, the second wavelength range may be outside the predetermined wavelength range.

In an exemplary approach, there may be a less than 10% change in transparency of the mixture for a second wavelength range in the ultraviolet to infrared range as the voltage of the electrode increases. For example, but not limited to, a smart window may include a mixture of nanoparticles comprised of material that absorbs in the IR region that continually blocks thermal, radioactive heat (blocking incoming IR via absorbance) while changing to transparency as the voltage of the electrode increases (providing clarity of the window via transmittance of visible light). As another example, the smart window may include a mixture of nanoparticles comprised of material that absorbs in the UV region that continually blocks UV radiation (blocking incoming UV via absorbance, e.g., ZnS) while changing to transparency as the voltage of the electrode increases (providing clarity of the window via transmittance of visible light).

As an example, a smart window may have core/shell colloidal particles that includes energy absorbing material that absorbs in the IR range but allows visible light through, so the smart window has transparency while blocking IR light, and thereby reducing heat typically generated by IR light. In another example of a smart window, core/shell colloidal particles may include material that absorbs UV light (for example, ZnS/SiO₂), thereby allowing sunlight through a window while blocking harmful UV light. Thus, depending on the type of material, optical band gaps ranging from UV, visual to IR may be created.

In other aspects, the mixture 106 may be characterized as having a transparency of at least 90% light transmission upon application of a predetermined voltage V to the electrode 108. In some approaches, the application of a predetermined voltage may increase the interparticle distance between the core/shell nanoparticles of the mixture. In other approaches, the application of a predetermined voltage may decrease the interparticle distance between the core/shell nanoparticles of the mixture.

In some aspects, a color hue of the mixture 106 may change as the transparency changes as a voltage V of the electrode 108 changes.

In various aspects, the colloidal nanoparticles 102 may migrate toward one side of the mixture 106 upon application of the voltage V to the electrode 108. In one aspect of product 100 as shown in FIG. 1B, the colloidal nanoparticles 102 may migrate toward the electrode 108, depending on voltage and charge of the nanoparticle. In another aspect, the colloidal nanoparticles 102 may migrate away from the electrode 108, depending on voltage and charge of the nanoparticle.

In various aspects, turning the voltage off and thereby removing the applied electric field may reverse the change in transparency, brightness, and/or color of the mixture 106 in the cell 120 that occurs in the presence of an applied electric field. In some approaches, turning the voltage off and thereby removing the applied electric field may reverse the color change of the mixture 106 in the cell 120 that occurs in the presence of an applied electric field. The color change and/or transparency change may be fully reversible. In some aspects, the response time corresponding to applied voltage may be almost instantaneous.

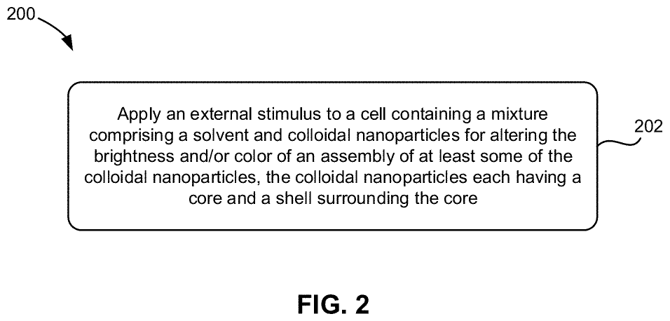

FIG. 2 shows a method 200, in accordance with one aspect. As an option, the present method 200 may be implemented to construct structures, devices, assemblies, etc., such as those shown in the other FIGS. described herein. Of course, however, this method 200 and others presented herein may be used to form structures for a wide variety of devices and/or purposes which may or may not be related to the illustrative aspects listed herein. Further, the methods presented herein may be carried out in any desired environment. Moreover, more or less operations than those shown in FIG. 2 may be included in method 200, according to various aspects. It should also be noted that any of the aforementioned features may be used in any of the aspects described in accordance with the various methods.

Method 200 includes operation 202. Operation 202 includes applying an external stimulus to a cell containing a mixture comprising a solvent and colloidal nanoparticles for altering the brightness and/or color of an assembly of at least some of the colloidal nanoparticles, e.g., as described in detail above with reference to FIGS. 1A-1C. In some aspects, the colloidal nanoparticles each have a core and a shell surrounding the core. In various approaches, the external stimulus is applied to at least one electrode of the cell containing the mixture. The at least one electrode is preferably coupled to at least one spacer forming a chamber having sides defining an interior where the mixture is contained within the interior of the chamber.

In at least some approaches, the external stimulus is a voltage applied to at least one electrode of the cell containing the mixture. The interparticle distance between the colloidal nanoparticles is adjusted upon application of the voltage to at least one electrode where the colloidal nanoparticles may migrate toward at least one side of the mixture upon application of the voltage to the electrode. According to some aspects, a cell comprising the mixture of a solvent and the colloidal nanoparticles may be coupled to at least two electrodes.

In various approaches, the average interparticle distance as the external stimulus is applied is less than about 100 nm. In other approaches, the average interparticle distance as the external stimulus is applied is adjusted to be between about 10 nm to 500 nm, as determined by the amount, extent, proportion, etc., of the external stimulus which is applied. A desired (e.g., predetermined) interparticle distance would be determinable by one having ordinary skill in the art upon reading the present disclosure further in view of the intended application. An amount, extent, proportion, etc., of the external stimulus applied to the cell comprising the colloidal nanoparticles (e.g., for adjusting the interparticle distance to a predetermined interparticle distance) would similarly be determinable by one having ordinary skill in the art upon reading the present disclosure further in view of the intended application.

In some approaches, the external stimulus may be in the form of an electrophoretic deposition (EPD) process. In yet other approaches, the external stimulus may be in the form of touch, stress, pressure, light (e.g., for exciting luminescent materials in the core of the colloidal nanoparticles), any other force, etc., or any combination thereof. A plurality of external stimuli may be applied in at least some aspects.

In various aspects, the adjusted interparticle distance alters the brightness and/or color of an assembly of at least some of the colloidal nanoparticles. According to at least some approaches, the colloidal nanoparticles each have a core and a shell surrounding the core. In preferred approaches, the core comprises a luminescent material and the shell is silicon-based. The luminescent material may be phosphor-based in at least some aspects. In other aspects, the luminescent material comprises quantum dots.

According to at least some of the aspects described throughout the present disclosure, adjusting the interparticle distance alters the brightness of an assembly of at least some of the colloidal nanoparticles where altering may include increasing or decreasing the brightness, as would become apparent to one having ordinary skill in the art upon reading the present disclosure. Similarly, adjusting the interparticle distance may alter (e.g., by increasing or decreasing) the darkness of the assembly of at least some of the colloidal nanoparticles. Adjusting the interparticle distance alters the color of an assembly of at least some of the colloidal nanoparticles where altering the interparticle distance may include increasing or decreasing the saturation of the color, as would become apparent to one having ordinary skill in the art upon reading the present disclosure.

In various approaches, increasing or decreasing the voltage (e.g., electric field) applied to the at least one electrode may alter the brightness and/or color of the assembly of at least some of the colloidal nanoparticles. The electric field is preferably controlled on demand in order to adjust the brightness and/or color. As the colloidal nanoparticles assemble (e.g., in response to the application of the external stimulus), the frequency and/or intensity of the brightness and/or color may be altered by matching the scattering effects with the emission of color (e.g., originating from the luminescent material in the core of the nanoparticles). The ordering of at least some of the colloidal nanoparticles is non-binary (e.g., there are various phases of ordering between substantially randomly ordered and relatively highly ordered).

In various approaches, the degree of brightness and/or color of at least some of the colloidal nanoparticles is based at least in part on the ordering of the colloidal nanoparticles (e.g., and the associated interparticle distance). The interparticle distance is related to the amount of light which may enter the assembly of at least some of the colloidal nanoparticles. The incoming light may further excite the core/shell structures of the colloidal nanoparticles, including the luminescent materials of the cores.

Experimental Methods and Results

Synthesis and Characterization of Uniform and Size Controllable Highly Efficient Luminescent Colloidal Core/Shell Nanoparticles

Rational Choice of Luminescent Core/Shell Materials

The lanthanide (Ln) activated luminescent materials are chosen due to their narrower spontaneous emission and excitation band widths, which are ideal to efficiently interact with photonic band gaps in PCs. Furthermore, these materials have stimulated heightened interest in the materials—particularly for applications in which lanthanide ions up-convert (UC) incident near-infrared (NIR) radiation into visible light. The ability to encapsulate such functionality into dispersible, photostable colloids enables upconverting nanoparticles to be utilized as biological imaging agents, in luminescence photovoltaic concentrators, and in inks for anti-counterfeit labels. Specifically, NaYF₄ can be used as a core material where NaYF₄ nanocrystals are considered to be one of the most efficient NIR-to-visible UC material and the emission wavelength may be tuned by doping different types or amounts of activators (e.g., Er, Yb, and Tm) at the same absorption features. Additionally, the synthetic temperature is relatively low (e.g., less than about 300° C.) and thus post-synthesis treatment such as thermal annealing that can degrade the particle suspension properties resulting in detrimental effects of particle assemblies is not necessary to obtain highly efficient luminescence. As a shell material, silica is an optimal material. SiO₂ shells improve the suspension properties of the nanoparticles due to the negative surface charge of the shells. In responsive PCs, the suspension properties of colloidal nanoparticles are important to maintain the particle assemblies and structures. In addition, the surface charge of SiO₂ shell makes the particles effectively responsive to an external electric field. Second, by modifying the SiO₂ shells thickness, the interparticle distance may be controlled, which contributes to the photonic band gap characteristics.

Rapid and Scale-Up Synthesis of Size Controllable and Highly Efficient Luminescent Core/Shell Nanocrystals and Material Characterization

Increasing the number of components in a material such as the crystal structure of NaYF₄, activator concentrations, and size-dependent surface quenching effects, increases the number of combinations to be explored in order to optimize a desired property. Various approaches include rapid and scale-up synthesis to optimize the compounds with not only high quality of luminescence output, but also ideal particle size, and size distribution for responsive PCs. For this purpose, high throughput combinatorial methods may be used. The microwave assisted synthesis provides a variety of size and compositions in a relatively fast manner. This technique produces nanocrystals having SiO₂ coatings in a processing time of about 10 min, which is dramatically faster than typical batch process (e.g., about 2 to about 5 hours). In addition to fast reaction, microwave irradiation produces efficient internal heating by direct coupling of microwave energy with the molecules that are present in the reaction mixture, which is highly efficient internal heat transfer compared to typical nanoparticle batch synthesis. Due to its uniform and efficient heating and time-efficiency, microwave assisted synthetic method may be used to relatively easily and efficiently produce a relatively high quantity and quality of nanocrystals in a short amount of time.

Design and Fabrication of Multi-Functional Smart Optical Devices

Using size controllable luminescent core/shell nanocrystals and their structures, various types of light-matter interactions in a tunable PC device using electrophoretic deposition process (EPD) may be fabricated and demonstrated. Due to the negative surface charge of exemplary SiO₂ shells, the core/shell nanoparticles are concentrated on the positive electrode under application of an external electric field (as shown in FIGS. 1A-1C). The resulting structure of particle assembly is dynamically changed by the applied field, enabling control over the photonic band gap characteristics resulting in reflection and transmission tunability. Furthermore, when combined with luminescence characteristics from building blocks in PC, on-demand control is enabled for light-matter interactions such as luminescence, transmission, and reflection depending on the purposes of use.

In past decade, strong light-matter interactions in luminescence nanocrystals have been demonstrated when combined with PC structures. It is found that the spectral overlap between stop-band position determined by structural parameters of PC and emission and excitation features from optical properties of the luminescent nanocrystals is critical to affect the luminescence output (see, “Yin, Z.; Zhu, Y.; Xu, W.; Wang, J.; Xu, S.; Dong, B.; Xu, L.; Zhang, S.; Song, H. Remarkable enhancement of upconversion fluorescence and confocal imaging of PMMA Opal/NaYF₄: Yb³⁺, Tm³⁺/Er³⁺ nanocrystals. Chemical Communications 2013, 49, 3781-3783”). Specifically, the luminescence output is enhanced when the excitation wavelength of luminescent nanocrystals matches well with the stop-band of PCs and the luminescence is suppressed when the stop-band position in the PCs is overlapped with emission spectra of luminescent crystals.

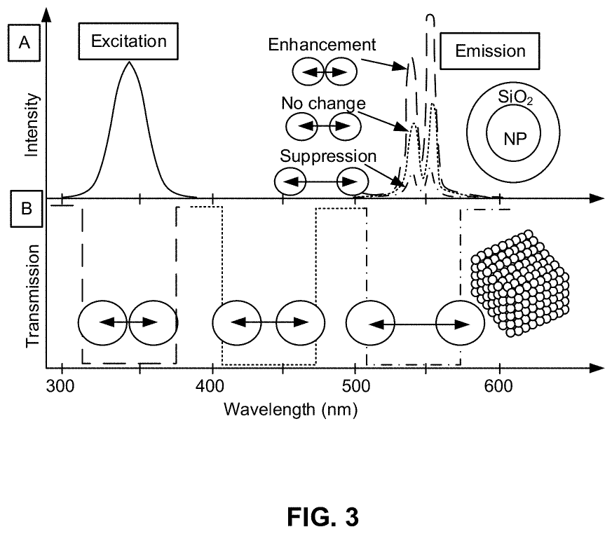

Based on these observations, the inventors have hypothesized the effect of spectral overlap between dynamically responsive PC and luminescence characteristics on the emission output, as shown in FIG. 3. FIG. 3 is a diagram of the hypothesized effect of spectral overlap between the stop-band of the PC and excitation and emission spectra of luminescent nanoparticles on the emission output. The top portion of FIG. 3(A) shows the excitation and emission spectra of luminescent nanocrystals. The bottom portion of FIG. 3(B) shows the tunable stop-band position of PC depending on the interparticle distance. The inventors have demonstrated that using EPD process, the stop-band position is blue-shifted and varies from visible to UV as applied field increases, due to shorter interparticle distances at higher applied field. The results indicate that it is possible to dynamically control the stop-band position in order to match with typical lanthanide doped luminescent emission and excitation spectra by tuning structural parameters of PCs (e.g., interparticle distance) using EPD processes.

The transmission of the cell is also dynamically tunable in response to electric stimuli. The inventors have found that the transmission changes from opaque to transparent due to enhanced crystallinity of particle assemblies as applied field increases, as shown in FIG. 4. FIG. 4 is a photograph of ZnS/SiO₂ suspensions in an EPD cell with a background on the backside of the device at the (A) OFF and the (B) ON state. The results show the potential to dynamically tune the transparency and optical clarity of the PC constructed by luminescent nanocrystals using EPD process after optimizing the structural parameters of PC (e.g., particle size, size distribution, shell thickness, etc.). Furthermore, the transmission and the luminescence may be tunable by simultaneously tuning the applied field. For example, both luminescence output and transmission are enhanced at higher applied field at least in part due to the spectral overlap between the stop-band and excitation spectra of luminescence nanocrystals (e.g., the top-most curve in FIG. 3) and the increased crystallinity. The luminescence output may be dynamically tuned in response to electricity using the PC structures as described herein.

Uses

Various applications of at least some aspects of the present disclosure include smart displays (e.g., such as televisions, computer screens, laptop screens, commercial displays, etc.), smart sensors, smart detectors, smart LEDs, programmable LED displays, see-through displays and/or lighting, etc. Various of the foregoing applications may comprise devices having a plurality of the cells described in detail throughout the present disclosure. In one exemplary device having a plurality of cells, each cell may include colloidal nanoparticles emitting at least one color, or a plurality of colors, as would be determinable by one having ordinary skill in the art upon reading the present disclosure and in view of the intended application. For example, at least some of the plurality of cells may comprise nanoparticles comprising a different luminescent material than other of the cells. Each cell in an exemplary smart display device may be configured to emit at least one color, or a plurality of colors, for collectively generating an image, text, video data, etc., where each cell acts analogously to a pixel in a display device.

Further applications include smart window technology for commercial and residential buildings as well as in the automotive industry. Smart window technology is motivated by the potential for significant energy savings from reduced cooling and heating loads. In particular, smart glass using a suspended particle device (SPD) adapted for controlling the transmission of radiation would provide benefits in instant and precise light control, long lifetime, and cost-effectiveness. Such devices have numerous applications, for example, architectural windows for commercial buildings and residences, windows for automotive vehicles, boats, trains, planes and spacecraft, electronic displays, filters for lamps, cameras, windows, sunroofs, toys, sun-visors, and eyeglasses.

Current conventional techniques to fabricate SPD-based smart windows use one-dimensional needle or rod-shaped dichroic materials whose alignment enables the light to pass through in the presence of applied electric field. However, the conventional technology does not provide tunability to colorations accompanied with transparency or translucence. Moreover, the choice of materials for use in conventional SPD-based smart windows is limited due to the difficulty of fabrication of rod-shaped materials with dichroic properties.

Various aspects of the present disclosure may be used to further improve the versatility and functionality of SPD-based smart windows and to tune the transparency of the smart glass window without loss in performance.

The inventive concepts disclosed herein have been presented by way of example to illustrate the myriad features thereof in a plurality of illustrative scenarios, aspects, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects have been described above, it should be understood that they have been presented by way of example only, and not limitation. Thus, the breadth and scope of an aspect of the present invention should not be limited by any of the above-described exemplary aspects, but should be defined only in accordance with the following claims and their equivalents.

What is claimed is:

1. A product, comprising:
a cell having:
a mixture comprising a solvent and colloidal nanoparticles, the colloidal nanoparticles each having a core and a shell surrounding the core; and
at least one electrode.

2. The product of claim 1, wherein the core comprises a luminescent material.

3. The product of claim 2, wherein the luminescent material comprises quantum dots.

4. The product of claim 2, wherein the luminescent material is phosphor-based.

5. The product of claim 1, wherein the shell is silicon-based.

6. The product of claim 1, wherein an interparticle distance between the colloidal nanoparticles is adjusted upon application of a voltage to the at least one electrode.

7. The product of claim 6, wherein the interparticle distance is adjusted to a be in a range of about 10 nm to about 500 nm.

8. The product of claim 1, comprising at least one spacer forming a chamber having sides defining an interior, wherein the mixture is in the interior of the chamber.

9. The product of claim 1, the product comprising a plurality of cells.

10. The product of claim 9, wherein the product is in the form of a smart display.

11. The product of claim 9, wherein at least some of the plurality of cells comprise nanoparticles comprising a different luminescent material than other of the cells.

12. The product of claim 1, the mixture having a specific color, the mixture being characterized as changing color across the visible spectrum in direct correlation to a concentration of the colloidal nanoparticles wherein a concentration of the colloidal nanoparticles is selected to provide the specific color of the mixture.

13. A product, comprising:
a nanoparticle having:
a core; and
a shell,
wherein the core comprises a luminescent material,
wherein the shell is silicon-based.

14. The product of claim 13, wherein the luminescent material is phosphor-based.

15. The product of claim 14, wherein the luminescent material comprises quantum dots.

16. A method, comprising,
applying an external stimulus to a cell containing a mixture comprising a solvent and colloidal nanoparticles for altering the brightness and/or color of an assembly of at least some of the colloidal nanoparticles, the colloidal nanoparticles each having a core and a shell surrounding the core.

17. The method of claim 16, wherein the external stimulus is a voltage applied to at least one electrode of the cell containing the mixture.

18. The method of claim 17, wherein the voltage is applied to the at least one electrode coupled to at least one spacer forming a chamber having sides defining an interior, wherein the mixture is in the interior of the chamber.

19. The method of claim 17, wherein an interparticle distance between the colloidal nanoparticles is adjusted upon application of the voltage to the at least one electrode.

20. The method of claim 19, wherein the interparticle distance is adjusted to a be in a range of about 10 nm to about 500 nm.
